(19) United States
(12) Patent Application Publication
(10) Pub. No.: US 2024/0194109 A1
(43) Pub. Date: Jun. 13, 2024

(54) METHOD FOR DRIVING DISPLAY AND DISPLAY

(71) Applicants: Huizhou China Star Optoelectronics Display Co., Ltd., Huizhou, Guangdong (CN); Shenzhen China Star Optoelectronics Semiconductor Display Technology Co., Ltd., Shenzhen, Guangdong (CN)

(72) Inventor: Xiaobing LU, Huizhou, Guangdong (CN)

(73) Assignees: Huizhou China Star Optoelectronics Display Co., Ltd., Huizhou (CN); Shenzhen China Star Optoelectronics Semiconductor Display Technology Co., Ltd., Shenzhen (CN)

(21) Appl. No.: 17/769,771

(22) PCT Filed: Jan. 20, 2022
(86) PCT No.: PCT/CN2022/072941

§ 371 Date: Apr. 18, 2022

(51) Int. Cl. G09G 3/20

(52) U.S. Cl. CPC G09G 3/2007; G09G 2320/0247; G09G 2320/0276; G09G 2330/023

(57) ABSTRACT

The present application relates to a method for driving a display and a display, wherein the method includes following steps: obtaining a gray-scale data of a target frame image according to a display data of the target frame image; configuring a voltage value of a first power supply voltage of the display based on the gray-scale data to obtain a voltage value of a second power supply voltage; caching the voltage value of the second power supply voltage; and updating the cached voltage value of the second power supply voltage in real time according to a current update time of the target frame image.

### TECHNICAL FIELD

The present application relates to a field of display, and in particular, to a method for driving a display and a display.

### BACKGROUND

Large-sized, high refresh rate, and high resolution display panels generally have excessive power consumption. At present, in order to control ecological environment pollution and improve environmental performance of energy-consuming products, it is more urgent to reduce the power consumption of the large-sized, high refresh rate, and high resolution display panels.

In addition, related technical solutions not only consume too much power in practical applications, but also have a picture flickering problem. Therefore, how to ensure quality of a display picture while reducing power consumption of a display panel is an urgent problem to be solved.

### Technical Problem

The present application mainly aims at reducing power consumption of a display panel and ensuring quality of a display picture.

### Technical Solution

In view of this, the present application provides a method for driving a display and a display, which can dynamically and adaptively adjust a voltage value of a second power supply voltage, effectively avoid a screen flicker problem, and ensure quality of a display picture while ensuring reduction of energy consumption of a display panel.

According to an aspect of the present application, there is provided a method for driving a display, wherein the method comprises wherein the method comprises following steps: obtaining a gray-scale data of a target frame image according to a display data of the target frame image; configuring a voltage value of a first power supply voltage of the display based on the gray-scale data to obtain a voltage value of a second power supply voltage; caching the voltage value of the second power supply voltage; and updating the cached voltage value of the second power supply voltage in real time according to a current update time of the target frame image.

According to another aspect of the present application, there is provided a display, wherein the display comprises: a gray-scale obtaining module electrically connected to a power supply configuration module for obtaining gray-scale data of a target frame image according to display data of the target frame image; a power supply configuration module electrically connected to the gray-scale obtaining module and a power supply caching module for configuring a voltage value of a first power supply voltage of the display based on the gray-scale data to obtain a voltage value of a second power supply voltage; a power supply caching module electrically connected to the power configuration module and a power supply updating module for caching the voltage value of the second power supply voltage; and a power supply updating module electrically connected to the power supply caching module for updating the cached voltage value of the second power supply voltage in real time according to a current update time of the target frame image.

### Technical Effects

Obtaining a gray-scale data of a target frame image according to a display data of the target frame image; followed by configuring a voltage value of a first power supply voltage of the display based on the gray-scale data to obtain a voltage value of a second power supply voltage; then caching the voltage value of the second power supply voltage; and finally updating the cached voltage value of the second power supply voltage in real time according to a current update time of the target frame image. According to various aspects of the present application, the present application can dynamically and adaptively adjust a voltage value of a second power supply voltage, effectively avoid a screen flicker problem and ensure quality of a display picture while ensuring reduction of energy consumption of a display panel.

### BRIEF DESCRIPTION OF THE DRAWINGS

The technical solutions and other beneficial effects of the present application will be apparent from detailed description of specific embodiments of the present application with reference to the accompanying drawings.

FIG. 1 is a flowchart of a method for driving a display according to an embodiment of the present application.

FIG. 2 is a schematic diagram before a gray-scale transformation according to an embodiment of the present application.

FIG. 3 is a schematic diagram after the gray-scale transformation according to an embodiment of the present application.

FIG. 4 is a schematic diagram of serial communication according to an embodiment of the present application.

FIG. 5 is a schematic diagram of a method for driving the display according to an embodiment of the present application.

FIG. 6 is a schematic structural diagram of the display according to an embodiment of the present application.

### DETAILED DESCRIPTION

Hereinafter, technical solution in embodiments of the present application will be clearly and completely described with reference to the accompanying drawings in embodiments of the present application. Obviously, the described embodiments are part of, but not all of, the embodiments of the present application. All the other embodiments, obtained by a person with ordinary skill in the art on the basis of the embodiments in the present application without expenditure of creative labor, belong to the protection scope of the present application.

In description of the present application, it should be understood that the terms “center”. “longitudinal”, “transverse”, “length”, “width”, “thickness”, “upper”, “lower”, “front”, “back”, “left”, “right”, “vertical”, “horizontal”, “top”, “bottom”, “inner”, “outer”, “clockwise”, “counterclockwise”, etc., that indicating an orientation or a positional relationship are based on an orientation or a positional relationship shown in the accompanying drawings, which are merely intended to facilitate the description of the present application and simplify the description, and are not intended to indicate or imply that a device or an element must have a specific orientation, be constructed and operated in a specific orientation, and therefore cannot be construed as a limitation of the present application. In addition, the terms “first” and “second” are used for descriptive purposes only and cannot be understood as indicating or implying relative importance or implying a number of the indicated technical features. Thus, the features defined by “first” and “second” may explicitly or implicitly include one or more of the features. In the description of the present application, “multiple” means the meaning of two or more than two, unless otherwise specifically defined.

In description of the present application, it should be noted that the terms “installation”. “connection” and “linking” should be broadly understood, for example, it may be a fixed connection, a detachable connection, or an integral connection, unless otherwise specified and defined. It may be a mechanical connection or an electrical connection, or may communicate with each other. It may be a direct connection or an indirect connection via an intermediate medium, may be an internal communication within two elements or an interaction between two elements. The specific meaning of the above terms in the present application may be understood by a person skilled in the art according to specific situations.

The following disclosure provides many different embodiments or examples for implementing different structures of the present application. In order to simplify the disclosure of the present application, components and arrangements of specific examples are described below. Of course, they are examples only and are not intended to limit the present application. Furthermore, in the present application, reference numbers and/or reference letters may be used repeatedly in different examples, such repetition is for sake of simplicity and clarity, which in itself does not indicate the relationship between the various embodiments and/or arrangements discussed. In addition, the present application provides examples of various specific processes and materials, but one of ordinary skill in the art may recognize the application of other processes and/or the use of other materials. In some examples, methods, means, elements, and circuits well known to a person skilled in the art are not described in detail to highlight the subject matter of the present application.

A method for driving a display, wherein the method comprises following steps:
obtaining a gray-scale data of a target frame image according to a display data of the target frame image;
configuring a voltage value of a first power supply voltage of the display based on the gray-scale data to obtain a voltage value of a second power supply voltage; caching the voltage value of the second power supply voltage; and updating the cached voltage value of the second power supply voltage in real time according to a current update time of the target frame image.

Obtaining a gray-scale data of a target frame image according to a display data of the target frame image; followed by configuring a voltage value of a first power supply voltage of the display based on the gray-scale data to obtain a voltage value of a second power supply voltage; then caching the voltage value of the second power supply voltage; and finally updating the cached voltage value of the second power supply voltage in real time according to a current update time of the target frame image. According to various aspects of the present application, the present application can dynamically and adaptively adjust the voltage value of the second power supply voltage, effectively avoiding a screen flicker problem and ensure quality of a display picture while ensuring reduction of energy consumption of a display panel.

FIG. 1 is a flowchart of a method for driving a display according to an embodiment of the present application.

As shown in FIG. 1, a display in an embodiment of the present application may comprise a driving module and a display panel, the driving module is electrically connected with the display panel, and the driving module may be used to drive the display panel. The driving module may store display data of a target frame image in advance. A method for driving the display comprises following steps:

Step S10: obtaining a gray-scale data of a target frame image according to a display data of the target frame image.

Wherein the driving module stores display data of a target frame image in advance. For example, the driving module may be provided with a memory for storing display data of a target frame image in advance. Of course, the display picture of the display panel may comprise multiple frames, and the driving module may store display data of all frames of the display panel in advance.

Further, the target frame image of the display panel comprises a plurality of pixels, wherein at least one pixel is preset with a gray-scale corresponding to the pixel. The display data of the target frame image may be represented by a one-dimensional array or a multi-dimensional array, each element in the array may correspond to each pixel of the display picture, which is used to drive each pixel in the display panel to display according to a preset gray-scale. It is understood that the present application does not limit how the display data is represented.

Further, the gray-scale data of the target frame image may comprise a first gray-scale extreme value and a second gray-scale extreme value. In an embodiment of the present application, the first gray-scale extreme value of the target frame image may be a maximum value of a plurality of first gray-scales of the target frame image, and the second gray-scale extreme value of the target frame image may be a maximum value of a plurality of second gray-scales of the target frame image.

Further, the step of obtaining a gray-scale data of a target frame image according to a display data of the target frame image comprises following steps:

Step S101: obtaining a first gray-scale extreme value of the target frame image according to a display data of the target frame image.

Further, the first gray-scale may be a preset gray-scale, the display data of the target frame image may comprise a plurality of the first gray-scales, each of the first gray-scales corresponds to a pixel of the target frame image. For example, the gray-scale of display data of all frames of the display panel may be represented by an 8-bit binary number, and the gray-scale may range from 0 to 255. For a frame display picture, the frame display picture may comprise 1024*768 pixels, and the first gray-scale range of each pixel of the frame display picture may be 16 to 128, that is, for the frame display picture, the first gray-scale extreme value of the frame display picture may be 128, that is, the maximum gray-scale of the frame display picture.

Further, the target frame image may be divided into a plurality of display areas, the first gray-scale extreme value is a maximum value of a plurality of the first gray-scales in at least one of the plurality of display areas, and the second gray-scale extreme value is a maximum value of a plurality of second gray-scales in at least one of the plurality of display areas. The maximum gray-scale of each display area can be different. Therefore, the first gray-scale extreme value of the target frame image may also be a maximum value of a plurality of first gray-scales in one display area of the frame image. For example, the target frame image may be divided into two display areas. The first gray-scale range of the first display area is from 16 to 108, and the first gray-scale range of the second display area is from 32 to 116. In this case, the first gray-scale extreme value of the target frame image may be the maximum value 108 of the gray-scales in the first display area, or may be the maximum value 116 of the gray-scale in the second display area.

It should be noted that a first gray-scale may be arbitrarily selected within the first gray-scale range of the target frame image for processing, as long as the selected first gray-scale is conducive to reducing energy consumption of the display panel by using an embodiment of the present application. In this embodiment of the present application, the first gray-scale extreme value of the target frame image is a preferred solution, and how to select the first grayscale extreme value of the target frame image is not limited in the present application.

Step S102: transforming a plurality of first gray-scales of the target frame image to obtain a plurality of second gray-scales of the target frame image.

Further, the step of obtaining a first gray-scale extreme value of the target frame image according to display data of the target frame image comprises following steps:

Step S1011: obtaining a first gray-scale range of the target frame image according to the display data of the target frame image.

Step S1012: obtaining a first gray-scale extreme value of the target frame image according to the first gray-scale range.

Furthermore, since the target frame image may comprise a plurality of first gray-scales, each pixel in the target frame image may correspond to one first gray-scale, each of the first gray-scales may be transformed to obtain a plurality of second gray-scales after the transformation. Of course, in the process of transforming the plurality of first gray-scales of the target frame image, the plurality of first gray-scales of the target frame image may be divided into a plurality of sub-intervals, and the transformation may be segmented according to a plurality of sub-intervals. For another example, in a process of transforming a plurality of first gray-scales of the target frame image, only a first gray-scale corresponding to some pixels in the target frame image may be transformed, while a first gray-scale corresponding to other pixels in the target frame image may not be transformed. It may be understood that how to transform the plurality of first gray-scales of the target frame image is not limited in the present application.

It should be noted that the driving module may transform a plurality of first gray-scales of the target frame image based on a nonlinear characteristic between visual perception and brightness to obtain a plurality of transformed second gray-scales. Wherein, the visual perception can be represented by a brightness value that can be observed by human eyes, and the brightness can be represented by a brightness factor. Therefore, based on the nonlinear relationship between the visual perception and the brightness of the image, each pixel of the target frame image can be statistically analyzed to obtain a brightness value range of the target frame image. Of course, the gray-scale of the target frame image can also be statistically analyzed to obtain the range of the gray-scale.

Specifically, each second gray-scale of the plurality of transformed second gray-scales may correspond to a first gray-scale before the transformation, or may correspond to a plurality of first gray-scales before the transformation. It may be understood that different transformation modes may generate different corresponding relations between the first gray-scale and the second gray-scale, and the corresponding relations between the first gray-scale and the second gray-scale is not limited in the present application.

Further, the second gray-scale extreme value is a maximum value of a plurality of second gray-scales of the target frame image. That is, the second gray-scale extreme value has a similar meaning to the first gray-scale extreme value. For example, for a frame display picture, the frame display picture may comprise 1024*768 pixels, and the first gray-scale range of each pixel of the frame display picture may be 16 to 128, that is, for the frame display picture, the first gray-scale extreme value of the frame display picture may be 128. After transforming the plurality of first gray-scales of the target frame image, the second gray-scale range of each pixel of the frame display picture may be 32 to 216, and the first gray-scale extreme value of the frame display picture may be 216.

Further, the step of transforming a plurality of first gray-scales of the target frame image to obtain a second gray-scale extreme value of the target frame image comprises following steps:

Step S1021: transforming the plurality of first gray-scales of the target frame image to obtain a plurality of transformed second gray-scales.

Step S1022: obtaining a second gray-scale extreme value of the target frame image according to the plurality of transformed second gray-scales.

For example, step 1021 may be represented by the following formula (1):

$$Dout ( n ) = \{ \begin{matrix}{λ}_{1} \times {Din}_{n} , {C}_{0} < {Din}_{n} < {C}_{1} \\ {λ}_{2} \times {Din}_{n} , {C}_{1} < {Din}_{n} < {C}_{2} \\ … … \\ {λ}_{m} \times {Din}_{n} , {C}_{m - 1} < {Din}_{n} < {C}_{m}\end{matrix}$$

Wherein, Dinₙ may represent the first gray-scale of an input target frame image before the transformation of the n^{th} pixel; λ₁ may represent a coefficient corresponding to Dinₙ in a case where the first gray-scale of the n^{th} pixel point in the input target frame image is in a range of C0 to C1; λ₂ may represent a coefficient corresponding to Dinₙ in a case where the gray-scale of the n^{th} pixel point in the target frame image is in a range of C1 to C2. By analogy, λₘ may represent a coefficient corresponding to Dinₙ in a case where the gray-scale of the n^{th} pixel in the target frame image is in a range of Cₘ₋₁ to Cₘ. Dout (n) may represent the second gray-scale after the transformation of the n^{th} pixel point in the target frame image. m may be used to represent a number of the sub-intervals. In an example, C₀ may be 0 and Cₘ may be 255.

Further, the first gray-scale range of the target frame image is divided into a plurality of sub-intervals. For example, for a frame display picture, the frame display picture may comprise 1024*768 pixels, and the first gray-scale range of each pixel of the frame display picture may be 16 to 128, in this case, C₀ may be 16, Cₘ may be 32, and Cₘ may be 126. It may be understood that how to divide a plurality of sub-intervals and the number of sub-intervals is not limited in the present application.

Further, the first gray-scale corresponding to at least one pixel of the target frame image may be transformed according to formula (1). For example, a transform coefficient may be assigned to the first grayscale, and the transform coefficient can be multiplied with the first gray-scale to obtain a second gray-scale corresponding to the first gray-scale. The transform coefficients may be stored in a memory in advance. It may be understood that how the transform coefficients are determined is not limited in the present application.

By dividing the first gray-scale range of the target frame image into a plurality of sub-intervals, and transforming the plurality of first gray-scales of the target frame image according to the divided plurality of sub-intervals and a preset transform coefficient to obtain a plurality of transformed second gray-scales. An embodiment of the present application can be flexibly configured to transform the gray-scales of the target frame image, and further can dynamically and adaptively adjust the voltage value of the second power supply voltage in different application scenarios, further saving power consumption.

Step S20: configuring a voltage value of a first power supply voltage of the display based on the gray-scale data to obtain a voltage value of a second power supply voltage.

Further, the step of configuring a voltage value of a first power supply voltage of the display based on the gray-scale data to obtain a voltage value of a second power supply voltage comprises following steps:

Step S201: determining a voltage value of a first gamma voltage corresponding to the first gray-scale extreme value according to the first gray-scale extreme value.

Step S202: determining a voltage value of a gamma reference voltage according to the voltage value of the first gamma voltage.

Step S203: adjusting the voltage value of the first power supply voltage according to the voltage value of the gamma reference voltage to obtain the voltage value of the second power supply voltage.

For example, the voltage value of the gamma reference voltage is determined according to the voltage value of the first gamma voltage, the voltage value of the gamma reference voltage corresponding to the voltage value of the first gamma voltage may be determined first, and then the voltage value of the new gamma reference voltage can be determined again. Since the voltage value of the first gamma voltage at each stage is associated with the voltage value of the gamma reference voltage, after the voltage value of the new gamma reference voltage is redetermined, the voltage value of the first gamma voltage at the other stages is adjusted synchronously as a whole.

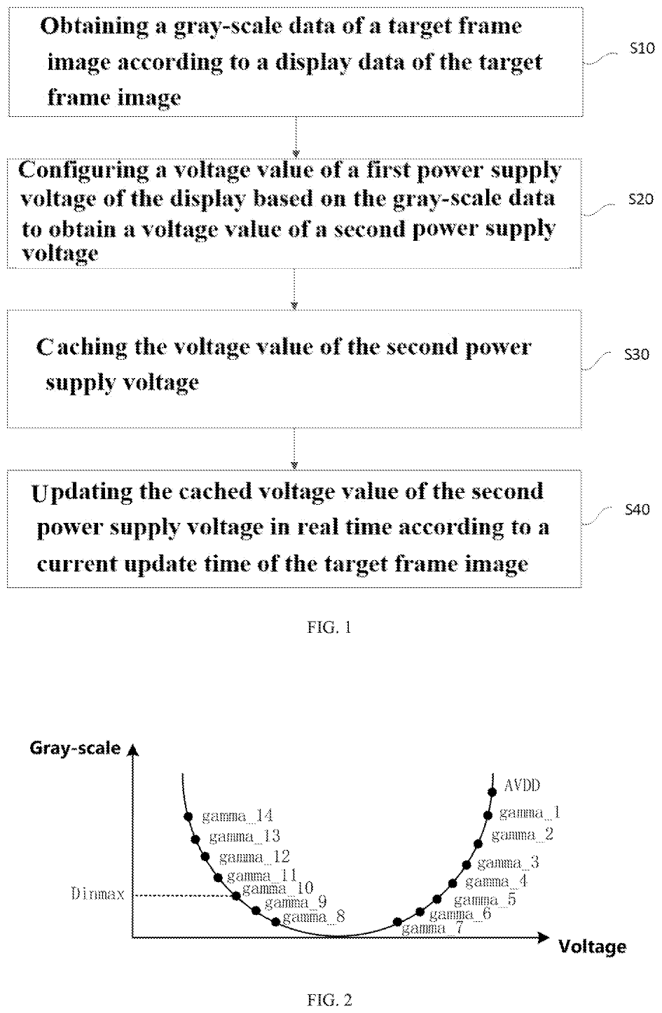

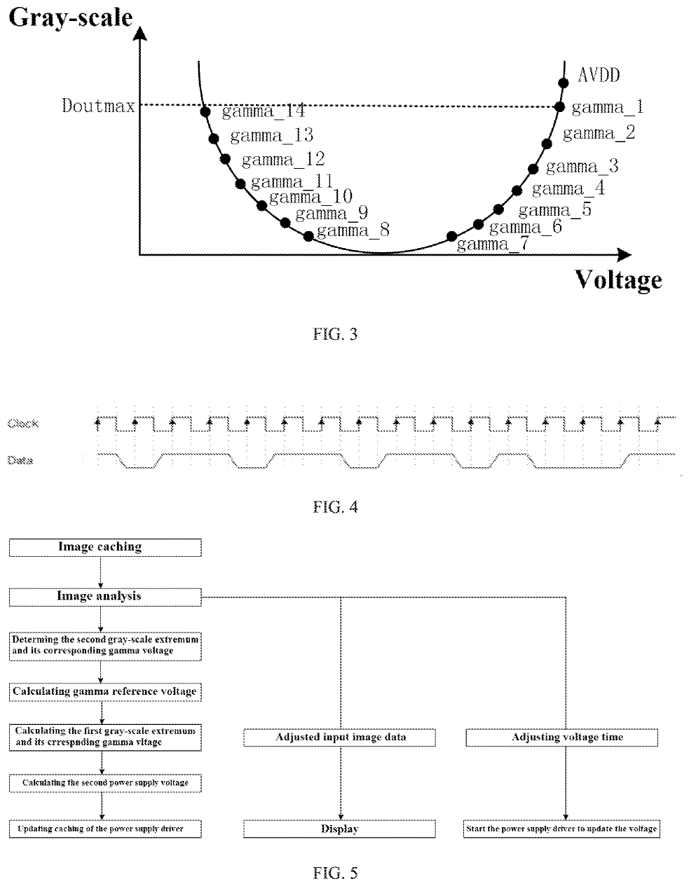

FIG. 2 is a schematic diagram before a gray-scale transformation according to an embodiment of the present application. FIG. 3 is a schematic diagram after a gray-scale transformation according to an embodiment of the present application.

As shown in FIGS. 2 and 3, the horizontal axis may represent voltage and the vertical axis may represent gray-scale. In FIG. 2, it can be seen that the maximum value of the first gray-scale of the target frame image may correspond to the voltage value of the 10th stage gamma voltage before the first gray-scale transformation. In FIG. 3, after the first gray-scale transformation, it can be seen that the maximum value of the second gray-scale of the target frame image may correspond to the voltage value of the first stage gamma voltage. That is, after transformation, the maximum value of the gray-scale of the target frame image may be larger than that before the transformation.

By using a segmented function in formula (1) for transformation, in an embodiment of the present application, the gray-scale of the target frame picture can adapt to the voltage value of the first power supply voltage, and the quality of the display picture after adjusting the voltage value of the first power supply voltage can be ensured.

In an embodiment of the present application, the first gray-scale extreme value may be a first gray-scale extreme value of a plurality of first gray-scale of a target frame image before transformation, and the second gray-scale extreme value may be a second gray-scale extreme value of a plurality of second gray-scale of a target frame image before transformation. The first gray-scale extreme value and the second gray-scale extreme value may be different. The voltage value of the preset first power supply voltage is adjusted by using the difference between the first gray-scale extreme value before transformation and the second gray-scale extreme value after transformation, so that a minimum voltage value of the first power supply voltage needed to ensure optimal display can be found, and the minimum voltage value of the first power supply voltage can be used as the voltage value of the second power supply voltage, thereby further reducing the energy consumption of the display panel while ensuring the display effect of the display panel.

Further, the step of adjusting the voltage value of the first power supply voltage according to the voltage value of the gamma reference voltage to obtain the voltage value of the second power supply voltage comprises following steps:

Step S2031: determining a voltage value of a second gamma voltage corresponding to the second gray-scale extreme value according to the second gray-scale extreme value.

Step S2032: adjusting a preset voltage value of the first power supply voltage according to the voltage value of the gamma reference voltage and the voltage value of the second gamma voltage to obtain the voltage value of the second power supply voltage.

In an example, 14 stages of gamma voltage are stored in the driving module in advance, and the voltage value at each stage of gamma voltage may correspond to a gray-scale. For example, the voltage value of the gamma voltage corresponding to a gray-scale of zero may be the voltage value of the first-stage gamma voltage, i.e., gamma_1. The voltage value of the gamma voltage corresponding to a gray-scale of 228 may be the voltage value of the 14th-stage gamma voltage, i.e., gamma_14. Further, the voltage values of 14 stages of gamma voltages may correspond to a voltage value of a first supply voltage (i.e., AVDD voltage). It should be noted that several groups of gamma voltage values may be set in the driving module, and the voltage value in each gamma group may comprise the voltage values of 14 stages of gamma voltages. It may be understood that the corresponding relationship among the gray-scales, the voltage value of the gamma voltage, and the voltage value of the first power supply voltage are not limited in the present application.

Further, the voltage value of the first gamma voltage corresponding to the first gray-scale extreme value is determined according to the first gray-scale extreme value, and may be expressed by formula (2) as follows:

gamma_num=ƒ1(Dinₘₐₓ)

Wherein, Dinₘₐₓ may represent a first gray-scale extreme value of an input target frame image; gamma_num represents the voltage value of the gamma voltage corresponding to the first gray-scale extreme value of the target frame image (i.e., the voltage value of the first gamma voltage); num may represent a stage numbers of voltage values of the gamma voltage, for example, gamma_num may be gamma_1 or gamma_3.

Similarly, Doutₘₐₓ may represent a second gray-scale extreme value of the transformed target frame image. The voltage value gamma_num′ of the second gamma voltage corresponding to the second gray-scale extreme value can be obtained by using formula (2) with Dinₘₐₓ as an input.

Further, the preset voltage value of the first power supply voltage may be represented by a string of binary numbers, for example, 1010 may represent that the voltage value of the first power supply voltage is 10 V. The voltage value of the preset first power supply voltage may be stored in a memory in advance. It may be understood that how to express the voltage value of the power supply voltage is not limited in the present application.

Further, the voltage value of the gamma reference voltage may be used to determine the voltage value of the second power supply voltage. The voltage value of the gamma reference voltage is determined according to the voltage value of the first gamma voltage, and may be expressed by formula (3) as follows:

gamma_ref=ƒ2(gamma_num)

Wherein, gamma_ref represents the voltage value of the gamma reference voltage, and gamma_num represents the voltage value of the first gamma voltage corresponding to the first gray-scale extreme value of the target frame image. Of course, the voltage value of the gamma reference voltage may also be determined according to the voltage value of the second gamma voltage.

Further, the voltage value of the preset first power supply voltage can be adjusted according to the voltage value of the gamma reference voltage and the voltage value of the first gamma voltage to obtain the voltage value of the second power supply voltage, which may be expressed by formula (4) as follows:

AVDD′=ƒ3(gamma_num,gamma_ref)

Wherein, AVDD′ represents the voltage value of the second power supply voltage obtained by adjusting the voltage value of the preset first power supply voltage. AVDD′ may be greater than the maximum value gamma_max of the voltage values of the plurality of second gamma voltages, and may be expressed by formula (5) as follows:

AVDD′=gamma_max+ΔV

Where ΔV may be greater than 0, indicating the difference between ΔVDD ‘and gamma_max. ΔV may be determined according to the situation and is not limited here.

It should be noted that in an embodiment of the present application, functions f1, f2 and f3 may be the same or different. It may be understood that, in actual application, corresponding functions may be configured according to actual needs, and functions f1, f2 and f3 are not limited in the present application.

By detecting the display data of the target frame image, the voltage value of the maximum gamma voltage corresponding to the gray-scale data is determined, and then the voltage value of the new gamma reference voltage is determined by analyzing the gamma, and the voltage value of the second power supply voltage according to the voltage value of the new gamma reference voltage is determined to be the minimum voltage value required for optimal display. An embodiment of the present application can dynamically adjust the power configuration of the display system to achieve the target of reducing the power consumption of the display, while ensuring picture quality and avoiding a picture flicker problem.

Step S30: caching the voltage value of the second power supply voltage.

FIG. 4 is a schematic diagram of serial communication according to an embodiment of the present application.

As shown in FIG. 4, for example, the voltage value of the second power supply voltage may be transmitted through a serial bus such as I2C and cached into the driving module. In FIG. 4, “Clock” may represent a transmission clock, and “Data” may represent voltage value data of the transmitted power supply voltage and display data of the target frame image. It may be understood that the serial bus mode may further comprise other data transmission modes such as SPI, and the serial bus mode is not limited in the present application.

Step S40: updating the cached voltage value of the second power supply voltage in real time according to a current update time of the target frame image.

Further, the step of updating the cached voltage value of the second power supply voltage in real time according to a current update time of the target frame image comprises:

Step S401: determining a current update time of the target frame image according to the display data of the target frame image.

Step S402: updating the cached voltage value of the second power supply voltage in real time according to the update time.

Wherein, the current update time of the target frame image may be associated with display data of the target frame image. In an example, a time node for transmitting the display data of the target frame image can be determined in combination with the image characteristics of the target frame image in an embodiment of the present application. For example, the display data of the target frame image may be sequentially transmitted in a time-sharing manner, or may be transmitted at one time as a whole. It can be understood that how to determine the current update time of the target frame image according to the display data of the target frame image is not limited in embodiments of the present application.

Further, working time of the target frame image comprises an effective display time and an ineffective display time, and the step of determining a current update time of the target frame image according to the display data of the target frame image comprises following steps:

Step S4011: determining the ineffective display time of the target frame image according to the display data of the target frame image.

Step S4012: determining the current update time of the target frame image within the ineffective display time.

Wherein, the display data of the target frame image may be transmitted according to a preset transmission cycle. Each transmission cycle may comprise an effective display time and an ineffective display time. The display data of the target frame image can be transmitted within an effective display time of one transmission cycle. The transmission of the display data of the target frame image may be suspended within an ineffective display time of one transmission cycle, and the cached voltage value of the second power supply voltage may be updated in real time. It can be understood that how to divide the effective display time and the ineffective display time is not limited in the present application.

By receiving the voltage value information of the power supply voltage in real time for caching, and updating the cached voltage value of the second power supply voltage in real time according to the update time of the display data of the target frame image in the ineffective display time, an embodiment of the present application can quickly respond to system update requirements, reasonably adjust the update time, ensure that the display power consumption is reduced while effectively avoiding the screen flicker problem, and ensure the display picture quality.

Further, the method for driving a display further comprises:

Step S50: adjusting a driving power of a display panel according to the voltage value of the second power supply voltage.

For example, adjusting a driving power of a display panel according to the voltage value of the second power supply voltage may be expressed by formula (6) as follows:

Power=ΔVDD′*I

Wherein, “Power” may represent power of a display panel in an embodiment of the present application, and “I” may represent a current corresponding to AVDD′. In the driving mode of the present application, AVDD′ can be minimized under the condition of ensuring the display quality, so that energy consumption of the display panel can be further reduced while display effect of the display panel is ensured.

FIG. 5 is a schematic diagram of a method for driving a display according to an embodiment of the present application.

As shown in FIG. 5, in an embodiment of the present application, for example, an input image data may be cached first, then image analysis is performed to find the first gray-scale range of the target frame image and the first gray-scale extreme value of the target frame image. The input display data is adjusted according to the first gray-scale range of the target frame image to obtain an adjusted input image data and a plurality of second gray-scales. Then, the second gray-scale extreme value and the voltage value of the second gamma voltage corresponding to the second gray-scale extreme value may be found among the plurality of second gray-scales, and the voltage value of the gamma reference voltage may be calculated. At the same time, the first gray-scale extreme value and the voltage value of the first gamma voltage corresponding to the first gray-scale extreme value may also be calculated. Finally, the adjusted AVDD value (i.e., the voltage value of the second supply voltage) is calculated and cached by an external power supply driver. At a same time, after the image is analyzed, the update time of the voltage can be adjusted, and the power supply driver is started to update the voltage at the update time, and finally, the display panel is driven to display a picture together with the adjusted input image data. It can be understood that the sequence in FIG. 5 does not constitute a limitation on the implementation steps in embodiments of the present application.

The present application further provides a display, the display comprising: a gray-scale obtaining module electrically connected to a power supply configuration module for obtaining gray-scale data of a target frame image according to display data of the target frame image; a power supply configuration module electrically connected to the gray-scale obtaining module and a power supply caching module for configuring a voltage value of a first power supply voltage of the display based on the gray-scale data to obtain a voltage value of a second power supply voltage; a power supply caching module electrically connected to the power configuration module and a power supply updating module for caching the voltage value of the second power supply voltage; and a power supply updating module electrically connected to the power supply caching module for updating the cached voltage value of the second power supply voltage in real time according to a current update time of the target frame image.

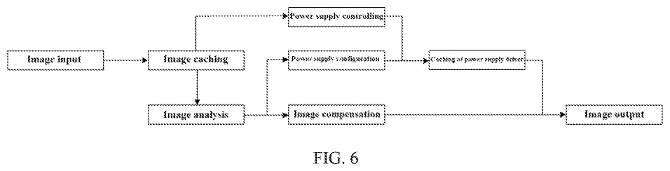

FIG. 6 is a schematic structural diagram of a display according to an embodiment of the present application.

As shown in FIG. 6, an input image can be cached. Wherein, image caching may be realized by a register. The image caching can read display data of a pre-stored target frame and cache it. When the image caching receives an instruction issued by the system to start image processing, the image caching may send display data of the cached target frame to image analysis for analysis.

Further, the image analysis may receive the display data of the target frame sent from the image caching, and analyze the display data of the target frame. Since there is a non-linear relationship between visual perception and brightness of an image, the visual perception can be characterized by a brightness value that can be observed by human eyes, and the brightness can be characterized by a brightness factor. Therefore, based on the non-linear relationship between visual perception and brightness of an image, each pixel of the target frame image can be statistically analyzed to obtain a brightness value range of the target frame image. Of course, the gray-scale of the target frame image can also be statistically analyzed to obtain a range of the gray-scales.

Further, based on the non-linear relationship between the visual perception of an image and the brightness, the gray-scale of the target frame image can be segmented, and the first gray-scale is transformed by using the segmented function to obtain the transformed second gray-scale.

Further, the voltage value of the power supply voltage may be configured based on results of image analysis, and the voltage value of the power supply voltage may be cached to the power supply driver in combination with power supply controlling, and finally the final image output may be controlled together with data after image compensation. It may be understood that the structure in FIG. 6 is exemplary, and the specific structure of the display is not limited in the present application.

In summary, in an embodiment of the present application, obtaining a gray-scale data of a target frame image according to a display data of the target frame image; followed by configuring a voltage value of a first power supply voltage of the display based on the gray-scale data to obtain a voltage value of a second power supply voltage; then caching the voltage value of the second power supply voltage; and finally updating the cached voltage value of the second power supply voltage in real time according to a current update time of the target frame image. According to various aspects of the present application, the present application can dynamically and adaptively adjust a voltage value of a second power supply voltage, effectively avoid a screen flicker problem, and ensure quality of a display picture while ensuring reduction of energy consumption of a display panel.

In the above embodiments, description of each embodiment has its own emphasis, for the parts that are not detailed in an embodiment, please refer to the related descriptions of other embodiments.

The method for driving a display and the display provided in embodiments of the present application are described in detail above. The principles and embodiments of the present application are described by using specific examples herein. Descriptions of the above embodiments are merely intended to help understand the technical solutions and core ideas of the present application. A skilled person in the art shall understand that it is still possible to modify the technical solutions described in the above embodiments or to equivalently replace some of the technical features therein. These modifications or substitutions do not separate the nature of the corresponding technical solutions from the technical solutions of each embodiment of the present application.

What is claimed is:

1. A method for driving a display, wherein the method comprises following steps:
obtaining a gray-scale data of a target frame image according to display data of the target frame image;
configuring a voltage value of a first power supply voltage of the display based on the gray-scale data to obtain a voltage value of a second power supply voltage;
caching the voltage value of the second power supply voltage; and
updating the cached voltage value of the second power supply voltage in real time according to a current update time of the target frame image.

2. The method for driving the display according to claim 1, wherein the gray-scale data comprises a first gray-scale extreme value and a second gray-scale extreme value, and the step of obtaining a gray-scale data of a target frame image according to a display data of the target frame image comprises following steps:
obtaining a first gray-scale extreme value of the target frame image according to the display data of the target frame image; and
transforming a plurality of first gray-scales of the target frame image to obtain a second gray-scale extreme value of the target frame image.

3. The method for driving the display according to claim 2, wherein the step of obtaining a first gray-scale extreme value of the target frame image according to the display data of the target frame image comprises following steps:
obtaining a first gray-scale range of the target frame image according to the display data of the target frame image; and
obtaining the first gray-scale extreme value of the target frame image according to the first gray-scale range.

4. The method for driving the display according to claim 3, wherein the steps of transforming a plurality of first gray-scales of the target frame image to obtain a second gray-scale extreme value of the target frame image comprises following steps:
transforming the plurality of first gray-scales of the target frame image to obtain a plurality of transformed second gray-scales; and
obtaining a second gray-scale extreme value of the target frame image according to the plurality of transformed second gray-scales.

5. The method for driving the display according to claim 2, wherein the step of configuring a voltage value of a first power supply voltage of the display based on the gray-scale data to obtain a voltage value of a second power supply voltage comprises following steps:
determining a voltage value of a first gamma voltage corresponding to the first gray-scale extreme value according to the first gray-scale extreme value;
determining a voltage value of a gamma reference voltage according to the voltage value of the first gamma voltage; and
adjusting the voltage value of the first power supply voltage according to the voltage value of the gamma reference voltage to obtain the voltage value of the second power supply voltage.

6. The method for driving the display according to claim 5, wherein the step of adjusting the voltage value of the first power supply voltage according to the voltage value of the gamma reference voltage to obtain the voltage value of the second power supply voltage comprises following steps:
determining a voltage value of a second gamma voltage corresponding to the second gray-scale extreme value according to the second gray-scale extreme value; and
adjusting a preset voltage value of the first power supply voltage according to the voltage value of the gamma reference voltage and the voltage value of the second gamma voltage to obtain the voltage value of the second power supply voltage.

7. The method for driving the display according to claim 1, wherein the step of updating the cached voltage value of the second power supply voltage in real time according to a current update time of the target frame image comprises following steps:
determining a current update time of the target frame image according to the display data of the target frame image; and
updating the cached voltage value of the second power supply voltage in real time according to the update time.

8. The method for driving the display according to claim 7, wherein working time of the target frame image comprises an effective display time and an ineffective display time, and the step of determining a current update time of the target frame image according to the display data of the target frame image comprises following steps:
determining the ineffective display time of the target frame image according to the display data of the target frame image; and
determining the current update time of the target frame image within the ineffective display time.

9. The method for driving the display according to claim 1, wherein the method further comprises a following step: adjusting a driving power of a display panel according to the voltage value of the second power supply voltage.

10. The method for driving the display according to claim 4, wherein the first gray-scale extreme value is a maximum value of the plurality of first gray-scales of the target frame image, and the second gray-scale extreme value is a maximum value of a plurality of second gray-scales of the target frame image.

11. A display, wherein the display comprises:
a gray-scale obtaining module electrically connected to a power supply configuration module for obtaining gray-scale data of a target frame image according to a display data of the target frame image;
the power supply configuration module electrically connected to the gray-scale obtaining module and a power supply caching module for configuring a voltage value of a first power supply voltage of the display based on the gray-scale data to obtain a voltage value of a second power supply voltage;
the power supply caching module electrically connected to the power configuration module and a power supply updating module for caching the voltage value of the second power supply voltage; and
the power supply updating module electrically connected to the power supply caching module for updating the cached voltage value of the second power supply voltage in real time according to a current update time of the target frame image.

12. The display according to claim 11, wherein the gray-scale data comprises a first gray-scale extreme value and a second gray-scale extreme value, and the gray-scale obtaining module comprises:
a first gray-scale extreme value obtaining module for obtaining a first gray-scale extreme value of the target frame image according to display data of the target frame image; and
a second gray-scale extreme value obtaining module for transforming a plurality of first gray-scales of the target frame image to obtain a second gray-scale extreme value of the target frame image.

13. The display of claim 12, wherein the first gray-scale extreme value obtaining module comprises:
a first gray-scale range obtaining module for obtaining a first gray-scale range of the target frame image according to display data of the target frame image; and
a first gray-scale extreme value obtaining submodule for obtaining the first gray-scale extreme value of the target frame image according to the first gray-scale range.

14. The display of claim 13, wherein the second gray-scale extreme value obtaining module comprises:
a first gray-scale transformation module for transforming a plurality of first gray-scales of the target frame image to obtain a plurality of transformed second gray-scales; and
a second gray-scale extreme value obtaining submodule for obtaining a second gray-scale extreme value of the target frame image according to the plurality of transformed second gray-scales.

15. The display of claim 12, wherein the power supply configuration module comprises:
a first gamma voltage determining module for determining a voltage value of the first gamma voltage corresponding to the first gray-scale extreme value according to the first gray-scale extreme value;
a gamma reference voltage determining module for determining a voltage value of the gamma reference voltage according to the voltage value of the first gamma voltage; and
an adjustment module for adjusting the voltage value of the first power supply voltage according to the voltage value of the gamma reference voltage to obtain the voltage value of the second power supply voltage.

16. The display of claim 15, wherein the adjustment module comprises:
a second gamma voltage determining module for determining a voltage value of a second gamma voltage corresponding to the second gray-scale extreme value according to the second gray-scale extreme value; and
an adjustment sub-module for adjusting a preset voltage value of the first power supply voltage according to the voltage value of the gamma reference voltage and the voltage value of the second gamma voltage to obtain the voltage value of the second power supply voltage.

17. The display of claim 11, wherein the power supply updating module comprises:
an update time determining module for determining a current update time of the target frame image according to the display data of the target frame image; and
a second power supply voltage updating module for updating the cached voltage value of the second power supply voltage in real time according to the update time.

18. The display of claim 17, wherein working time of the target frame image comprises an effective display time and an ineffective display time, and the update time determining module comprises:
an ineffective display time determining module for determining the non-effective display time of the target frame image according to the display data of the target frame image; and
an update time determining sub-module for determining a current update time of the target frame image within the ineffective display time.

19. The display according to claim 11, wherein the display further comprises a driving power adjustment module for adjusting a drive power of a display panel according to the voltage value of the second power supply voltage.

20. The display according to claim 14, wherein the first gray-scale extreme value is a maximum value of the plurality of first gray-scales of the target frame image, and the second gray-scale extreme value is a maximum value of a plurality of second gray-scales of the target frame image.
